(19) United States
(12) Patent Application Publication
(10) Pub. No.: US 2013/0243683 A1
(43) Pub. Date: Sep. 19, 2013

(54) METHOD FOR THE PRODUCTION OF HIGH-PURITY SILICON

(71) Applicants: Norbert Auner, Glashuetten (DE); Sven Holl, Gueckingen (DE); Christian Bauch, Muldenstein - Muldestausee (DE); Rumen Deltschew, Leipzig (DE); Javad Mohsseni, Leipzig (DE)

(72) Inventors: Norbert Auner, Glashuetten (DE); Sven Holl, Gueckingen (DE); Christian Bauch, Muldenstein - Muldestausee (DE); Rumen Deltschew, Leipzig (DE); Javad Mohsseni, Leipzig (DE)

(73) Assignee: Spawnt Private S.à.r.l., Luxembourg (LU)

(21) Appl. No.: 13/821,531

(22) PCT Filed: Sep. 8, 2011
(86) PCT No.: PCT/EP2011/065577

§ 371 Date: May 17, 2013

(30) Foreign Application Priority Data
Sep. 8, 2010 (DE) 102010044755.2

(51) Int. Cl. C01B 33/021

(52) U.S. Cl. CPC C01B 33/021
USPC 423/349

(57) ABSTRACT

A method for producing high-purity silicon is described. SiCl4 is produced from Si02-containing starting materials in a carbochlorination process, and the high-purity silicon is obtained from said SiCl4 in further steps of the method. No elemental silicon is added in any of the steps, resulting a particularly efficient and inexpensive method.

The present invention relates to a process for preparing high-purity silicon.

The prior art, for example DE 1102117 B or U.S. Pat. No. 3,042,494, discloses decomposition of trichlorosilane HSiCl₃ in the presence of hydrogen H₂ at high temperatures to give high-purity elemental silicon. This process is known as the Siemens process. E. Wolf, R. Teichmann, Zeitschrift für Chemie 1962 (2) 343 report that this reaction proceeds at 1000-1100° C. with a large hydrogen excess according to the following reaction equation:

HSiCl₃+H₂→Si3HCl.

Depending on the reaction conditions (for example E. Wolf, R. Teichmann, Zeitschrift für Chemie 1962 (2) 343: 800-900° C.), however, a second decomposition reaction which proceeds simultaneously to differing degrees in the absence of hydrogen leads to the formation of silicon tetrachloride SiCl₄:

4HSiCl₃→Si+3SiCl₄+2H₂.

A second process for preparing silicon, the Degussa process, is also based on a reaction of trichlorosilane and releases SiCl₄. This involves first producing monosilane SiH₄ by dismutation from HSiCl₃, in order to convert it to elemental silicon in a second step:

4HSiCl₃→SiH₄+3SiCl₄

SiH₄→Si+2H₂.

According to, for example, Winnacker/Küchler “Chemische Technologie” [Chemical Technology] Vol. 3, 4th ed., Carl Hanser Verlag, Munich, Vienna, 1983, p. 418 ff. or DE 1 105 398 B, HSiCl₃ is obtained in industrial processes for preparing high-purity silicon, in a reversal of the decomposition reaction, by reaction of HCl with metallurgical silicon, corresponding to the simplified equation:

Si+3HCl→HSiCl₃+H₂.

Depending on the reaction conditions and the presence of catalysts or impurities in the silicon used, silicon tetrachloride SiCl₄ is also formed as a by-product of the reaction. The reaction products are then separated by distillation and further purification processes, and the HSiCl₃ is obtained in purities suitable for preparation of high-purity silicon.

DE 10 2005 024 041 A1, for example, discloses a two-stage process for preparing silicon in which SiCl₄ is first reacted with H₂ in a plasma-chemical process to give a chlorinated polysilane, and the latter is then pyrolyzed to give silicon and SiCl₄, corresponding to the illustrative reaction equations:

SiCl₄+H₂→1/x(SiCl₂)ₓ+2HCl

2/x(SiCl₂)ₓ→Si+SiCl₄.

Recycling of the SiCl₄ into the first reaction step leads ultimately to the full conversion of the SiCl₄ to elemental silicon according to the overall equation:

SiCl₄+2H₂→Si+4HCl.

This patent specification likewise states that HSiCl₃ can be converted in the absence of hydrogen by plasma-chemical means to a chlorinated polysilane which can subsequently be pyrolyzed to silicon. This procedure can be described by the following simplified reaction equations:

2HSiCl₃→2/x(SiCl₂)ₓ+2HCl

2/x(SiCl₂)ₓ→Si+SiCl₄.

Likewise claimed is the conversion of other chlorinated monosilanes HₙSiCl₄₋ₙ (n=1-3), mixtures thereof or mixtures of chlorinated monosilanes and SiCl₄ in a plasma-chemical process to chlorinated polysilanes.

The prior art discloses that SiCl₄ can be reacted with hydrogen to give HSiCl₃:

SiCl₄+H₂→HSiCl₃+HCl.

Frequently, an excess of hydrogen is used in the industrial execution. For example, DE 2 209 267 A1 discloses the reaction of H₂/SiCl₄ mixtures at 600-1200° C. with subsequent quenching of the product gas mixture, and attains conversion rates of up to 37% to HSiCl₃. Performance of this reaction under plasma conditions, as described, for example, in U.S. Pat. No. 4,542,004 A or EP 0 100 266 A1, attains conversion rates of up to 64.5% to HSiCl₃. In some cases, under the reaction conditions described, the more highly hydrogenated H₂SiCl₂ is also formed. The reaction of SiCl₄ with atomic hydrogen, which is obtained by heating the gas with a light arc, is also described, for example, in DE 1 129 145 B. In this case, up to about 90% of the SiCl₄ used is converted to hydrogenated monosilanes HₙSiCl₄₋ₙ (n=1-3).

For example, DE 40 41 644 A1, DE 30 24 319 C2, or EP 0 100 266 A1 describe a two-stage process which combines the reaction of SiCl₄ with H₂ and the obtaining of HSiCl₃ from the HCl and Si released. It is also known that SiCl₄ can first be reacted with elemental silicon at 1100-1300° C., in order then to react the reaction products formed, :SiCl₂ and .SiCl₃, with HCl (for example from JP 02172811 A) according to the illustrative reaction equations:

SiCl₄+Si→2:SiCl₂

2 SiCl₂+2HCl→2HSiCl₃.

Frequently, the two reaction steps, the conversion of SiCl₄ and the reaction of HCl, are performed in a single reactor, as claimed, for example, in DE 10 2008 041 974 A1, JP 62-256713 A or JP 57-156319 A. The overall yield of HSiCl₃ is influenced by addition of catalysts and defined reaction conditions.

It becomes clear from the prior art described so far that the only process for recycling HCl into the production process for preparation of high-purity silicon necessitates the use of elemental silicon, albeit with low purity. The industrially customary process for preparing metallurgical silicon reacts SiO₂ in the form of quartz in electrical light arcs at temperatures of more than 2000° C. with an excess of carbon to give silicon (for example A. Schei, J. K. Tuset, H. Tveit in “High Silicon Alloys”, Tapir Forlag, Trondheim 1998, p. 13 ff, p. 47 ff):

SiO₂+2C→Si+2CO.

Moreover, for example, DE 10 2005 024 104 A1, DE 10 2005 024 107 A1, or DE 10 2007 009 709 A1 discloses that SiCl₄ can be obtained from SiO₂-containing material by a carbochlorination reaction at 1200-1400° C. using HCl:

SiO₂+4HCl+2C→SiCl₄+2H₂+2CO.

Rapid cooling of the product gas mixture prevents formation of H₂O with subsequent hydrolysis of the chlorosilane. This process has the advantage over the conventional process cited above for preparation of HSiCl₃ and/or SiCl₄ from silicon and HCl that the natural SiO₂ raw material need not first be converted in an energy-intensive manner to elemental silicon before the end product can be obtained. However, the sole silicon-containing product of the reaction is SiCl₄. HSiCl₃ cannot be prepared directly owing to the high reaction temperatures, as reported, for example, in N. Auner, S. Nordschild, Chemistry—A European Journal 2008 (14) 3694. DE 10 2005 024 104 A1 and DE 10 2005 024 107 A1 mention that hydrogen formed during the reaction of element halides with hydrogen halide can be used for deposition of the element halides. N. Auner, S. Nordschild, Chemistry—A European Journal 2008 (14) 3694 report that this hydrogen can be used not only for an energetic utilization but also as a reducing agent for deposition of high-purity elements. However, there is no further specification of the process in any of the cases.

It is an object of the invention to provide a process for preparing high-purity silicon which features a particularly high efficiency, and more particularly does not require the introduction of further raw materials and/or the discharge of additional waste substances.

This object is achieved in accordance with the invention by a process according to claim 1.

Developments of the process are evident from the dependent claims.

In the process according to the invention, high-purity silicon is prepared from SiO₂-containing starting materials, by first producing SiCl₄ by carbochlorination and then using the SiCl₄ produced in further steps to obtain the high-purity silicon. The process according to the invention is performed in such a way that no elemental silicon is supplied in any of the process steps. This achieves a particularly efficient and particularly inexpensive procedure.

In a further embodiment of the process, the carbochlorination reaction can be performed at temperatures of 700° C. to 1500° C., preferably temperatures of 800° C. to 1300° C., more preferably temperatures of 900° C. to 1100° C.

In a development of the process, by-products obtained in the process are recycled into the process and reused therein. This is preferably done with all by-products obtained in the process.

More particularly, HCl obtained in the process is used for carbochlorination.

In a further embodiment of the process according to the invention, the high-purity silicon obtained in the process is suitable for semiconductor applications and has less than 10 ppm, preferably less than 1 ppm and more preferably less than 1 ppb of impurities which adversely affect the electronic properties of the silicon for semiconductor applications. These impurities are elements of main groups 3 and 5 of the Periodic Table, especially B, Al, P, As, and also metals such as Ca and Sn and transition metals such as Fe. Such impurities can be determined by means of electrical measurements relating to the conductivity of the silicon and charge carrier lifetime in the silicon, or by means of mass spectrometry analyses, more particularly by means of IC-PMS (mass spectrometry with inductively coupled plasma).

In principle, the invention proposes four main variants for performance of the process according to the invention, in each of which the SiCl₄ obtained is converted to high-purity silicon in further process steps. These main variants of the process are described in claims 4, 8, 11 and 15. The accompanying dependent claims illustrate the use of the by-products obtained, especially HCl and hydrogen.

Chlorinated polysilanes in the context of the invention are those compounds or mixtures of those compounds which each contain at least one direct Si—Si bond, the substituents of which consist of chlorine or of chlorine and hydrogen, and the composition of which contains the atomic substituent:silicon ratio of at least 1:1.

During the preparation of SiCl₄ from SiO₂ by carbochlorination with HCl, a gas mixture is formed, from which the desired SiCl₄ product is separated, for example by condensation. The by-product which remains is a mixture of gases which, as well as H₂ and CO, may also contain residues of SiCl₄ and HCl. If necessary for further processing steps, SiCl₄ and HCl can be removed by simple gas scrubbing, for example with water or aqueous solutions.

The gas mixture containing H₂ and CO can be processed further in two ways. Firstly, it is possible to remove hydrogen by suitable separation processes, for example pressure swing adsorption or membrane separation processes. Secondly, the gas mixture can be subjected to a carbon oxide conversion with water vapor, in which further hydrogen is obtained according to

CO+H₂O→CO₂+H₂.

The carbon oxide conversion can be performed at lower temperatures than the carbochlorination since this is an exothermic process. The carbon oxide conversion can be performed, for example, at 200° C. to 500° C., preferably 300° C. to 450° C., using catalysts such as Co₃O₄, Fe/Cr or Cr/Mo catalysts or Cu/Zn catalysts.

Hydrogen can then be removed in a second step. In addition, the hydrogen-depleted gas mixture which results in the first case can also be subjected to a carbon oxide conversion, and a second removal of hydrogen can be effected.

The hydrogen obtained in this way can be used in the first process variant for further processing of the SiCl₄ obtained in the carbochlorination step. In a first embodiment, at least a portion of this hydrogen is used for hydrogenation of SiCl₄ with elimination of HCl to give chlorinated monosilanes HₙSiCl₄₋ₙ (n=1-3), and these are subsequently converted, if required with further H₂, to silicon and HCl by decomposition in the manner of the Siemens process. If additional H₂ is released during the decomposition reaction, this is used again for hydrogenation of SiCl₄. In both process steps, the HCl formed is separated from the product gas mixture and reused for preparation of SiCl₄ from SiO₂. The individual reaction steps can be represented in simplified form as follows:

SiO₂+4HCl+2C→SiCl₄+2H₂+2CO

SiCl₄+nH₂→HₙSiCl₄₋ₙ+nHCl (n=1-3)

HₙSiCl₄₋ₙxH₂→Si+4−nHCl+yH₂

(x=0 when n=2, 3; x=1 when n=1; y=0 when n=1, 2; y=1 when n=3).

SiCl₄, which can occur as a by-product of the reaction of chlorinated monosilanes to give silicon, can likewise be recycled into the production process, by reacting it again with H₂ to give chlorinated monosilanes.

In the second embodiment of the process, the hydrogen is used for hydrogenation of SiCl₄ with elimination of HCl to give chlorinated monosilanes HₙSiCl₄₋ₙ (n=1-3), and these are subsequently converted by dismutation to SiH₄ and subsequently in the Degussa process to silicon and H₂. In a further embodiment of the invention, the dismutation can be performed at temperatures of 0° C. to 400° C., preferably 0° C. to 150° C., with the possible presence of catalysts, for example the secondary and tertiary amines or quaternary ammonium salts mentioned in the DE patent application DE 2162537. The hydrogen formed is used together with further hydrogen from the carbochlorination to again obtain chlorinated monosilanes from the SiCl₄ obtained during the dismutation and the carbochlorination. The HCl formed is used again to obtain SiCl₄ by carbochlorination of SiO₂. The individual reaction steps correspond to the simplified reaction equations (when n=1-3):

nSiO₂+4nHCl+2nC→nSiCl₄+2nH₂+2nCO

4SiCl₄+4nH₂→4HₙSiCl₄₋ₙ+4nHCl

4HₙSiCl₄₋ₙ″nSiH₄+4−nSiCl₄

nSiH₄→nSi+2nH₂.

In the third embodiment of the process, the hydrogen is used to obtain chlorinated polysilane from SiCl₄ in a plasma-chemical process. This likewise produces HCl. The chlorinated polysilane is converted by pyrolysis to silicon and SiCl₄, and the SiCl₄ is recovered and subjected again to the plasma-chemical reaction. The procedure here may be as described in PCT application WO 2006/125425. The HCl is separated from the product gas mixture from the plasma-chemical process step and reused for preparation of SiCl₄ by carbochlorination of SiO₂. The individual reaction steps correspond to the illustrative simplified reaction equations:

SiO₂+4HCl+2C→SiCl₄+2H₂+2CO

2SiCl₄+2H₂→2/x(SiCl₂)x+4HCl

2/x(SiCl₂)x→Si+SiCl₄.

In the fourth embodiment of the process, the hydrogen is used for hydrogenation of SiCl₄ with elimination of HCl to give chlorinated monosilanes HₙSiCl₄₋ₙ (n=1-3), and these are subsequently converted in a plasma-chemical process to chlorinated polysilane and the latter is then pyrolyzed to elemental silicon and SiCl₄. Hydrogen which is released during the further processing of chlorinated monosilanes is likewise reused for hydrogenation of SiCl₄. The SiCl₄ from the pyrolysis is reused for preparation of chlorinated monosilanes. The HCl which is released during the plasma process and during the production of chlorinated monosilanes is reused for preparation of SiCl₄ by carbochlorination of SiO₂. The individual reaction steps correspond, for the example of HSiCl₃, to the simplified reaction equations:

SiO₂+4HCl+2C→SiCl₄+2H₂+2CO

2SiCl₄+2H₂→2HSiCl₃+2HCl

2HSiCl₃→2/x(SiCl₂)x+2HCl

2/x(SiCl₂)x→Si+SiCl₄.

In the plasma-chemical preparation of chlorinated polysilane, it is also possible to form hydrogen-containing chlorinated polysilanes. During the pyrolysis, these released not only SiCl₄ but also HCl and/or H₂. HCl formed in this way can be reused for preparation of SiCl₄ by carbochlorination of SiO₂. Hydrogen formed in this way can be recycled into the plasma-chemical process step or, for the fourth embodiment, also be used in the preparation of chlorinated monosilanes.

The pyrolysis of chlorinated polysilane can also release chlorinated monosilanes HₙSiCl₄₋ₙ (n=1-3). These can be reused in the plasma-chemical preparation of chlorinated polysilane. They can be separated from SiCl₄ by suitable processes and be used in the plasma-chemical reaction in the process according to the fourth embodiment, or else be introduced into the hydrogenation step in a mixture with SiCl₄.

During the preparation of chlorinated monosilanes HₙSiCl₄₋ₙ (n=1-3) in the preceding embodiments of the invention, it is also possible to form mixtures of compounds with different degrees of hydrogenation. These can firstly be separated in a suitable manner, for example by distillation, and the further conversion can be effected in corresponding separate process steps. Secondly, the mixtures of chlorinated monosilanes can be processed further without further separation into the components thereof.

The two embodiments with a plasma-chemical process step can be combined with one another, by using mixtures of SiCl₄ and chlorinated monosilanes for the production of the chlorinated polysilane, and using correspondingly smaller amounts of H₂ for the plasma-chemical reaction. Such mixtures are obtainable, for example, by not aiming for full conversion of the tetrachloride during the hydrogenation of SiCl₄, or forming mixtures of SiCl₄ and chlorinated monosilanes during the pyrolysis of chlorinated polysilane. It is likewise possible to subject, for example, only the SiCl₄ which is obtained from the pyrolysis, or else only the SiCl₄ which originates from the carbochlorination reaction, to the hydrogenation to give chlorinated monosilanes.

The two processes can also be combined by first producing chlorinated polysilane by plasma-chemical means from chlorinated monosilanes, while the SiCl₄ formed in the pyrolysis is subjected to a separate reaction with hydrogen for plasma-chemical preparation of chlorinated polysilane.

All embodiments correspond to the empirical equation:

SiO₂+2C→Si+2CO.

All additional auxiliaries (HCl, H₂) and intermediates (SiCl₄, HₙSiCl₄₋ₙ, SiH₄, chlorinated polysilane) are each conducted within a circulation process, such that there is no fundamental need to introduce further raw materials or to discharge additional waste materials. The four embodiments are shown schematically in FIGS. 1 to 6. According to the invention, no elemental silicon is used for conversion of auxiliaries, intermediates or reaction by-products.

In the industrial scale implementation of the processes, it is necessary merely to compensate for losses of HCl and H₂ which arise through contamination of the SiO₂ and carbon feedstocks, and during the separation and purification steps for isolation of intermediates.

The SiCl₄ obtained through carbochlorination of SiO₂ with HCl may contain impurities which make the material unfit for use for preparation of high-purity silicon. Contaminated SiCl₄ can, however, be purified adequately by prior art methods in order subsequently to be processed further to give high-purity silicon.

For embodiments of the process according to the invention which contain chlorinated monosilanes HₙSiCl₄₋ₙ (n=1-3) as intermediates, it is also possible to hydrogenate SiCl₄ having inadequate purity first to give chlorinated monosilanes, in order then to purify the chlorinated monosilanes or mixtures thereof with SiCl₄ by suitable processes.

In all cases, for full recycling of H₂ into the production processes, there is no additional need for hydrogen aside from the amount of gas obtained directly in the carbochlorination step. Especially the separation of CO and hydrogen can, however, be associated with losses of H₂ in the industrial implementation, and so additional production of H₂ by carbon oxide conversion can replace these losses.

In addition, the reactions of chlorosilanes SiCl₄ or HSiCl₃ with H₂ are frequently performed in the presence of an excess of hydrogen. After removal of the corresponding products and by-products, this excess hydrogen can be recycled into the production process. During this recovery step too, losses can occur, and these can be at least partly balanced out by the hydrogen originating from the carbon oxide conversion.

### DESCRIPTION OF THE FIGURES

FIG. 1 shows a simplified schematic diagram of the first embodiment of the process according to the invention in general form.

FIG. 2 shows a simplified schematic diagram of the first embodiment of the process according to the invention using the example of HSiCl₃ as an intermediate.

FIG. 3 shows a simplified schematic diagram of the second embodiment of the process according to the invention in general form.

FIG. 4 shows a simplified schematic diagram of the second embodiment of the process according to the invention using the example of HSiCl₃ as an intermediate.

FIG. 5 shows a simplified schematic diagram of the third embodiment of the process according to the invention.

FIG. 6 shows a simplified schematic diagram of the fourth embodiment of the process according to the invention using the example of HSiCl₃ as an intermediate.

FIG. 7 shows a ¹H NMR spectrum of a halogenated polysilane which has been obtained by means of a plasma-chemical reaction from SiCl₄ and H₂.

FIG. 8 shows a ²⁹Si NMR spectrum of the halogenated polysilane from FIG. 7.

FIG. 9 shows a ²⁹Si NMR spectrum of the reaction product from the reaction of SiCl₄ with H₂.

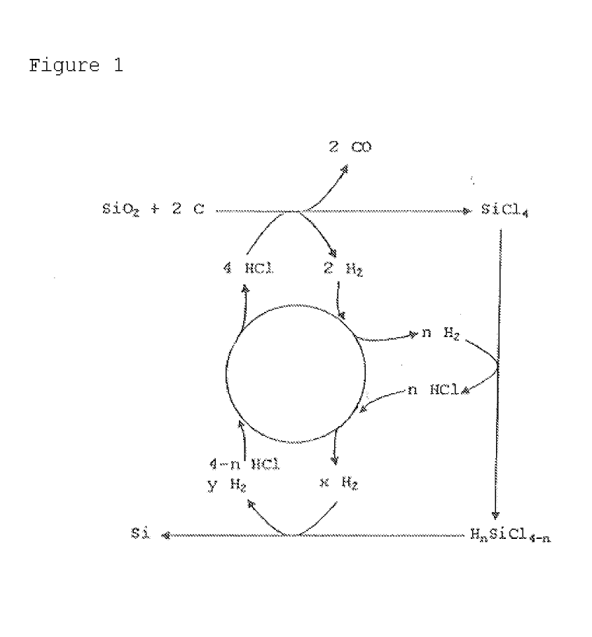

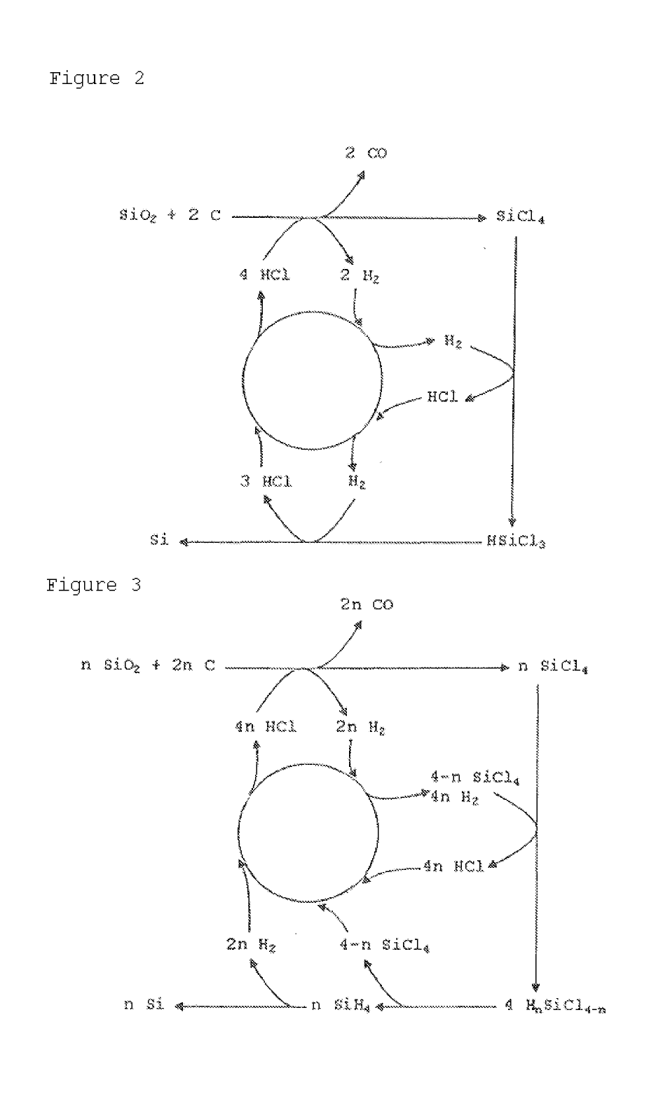

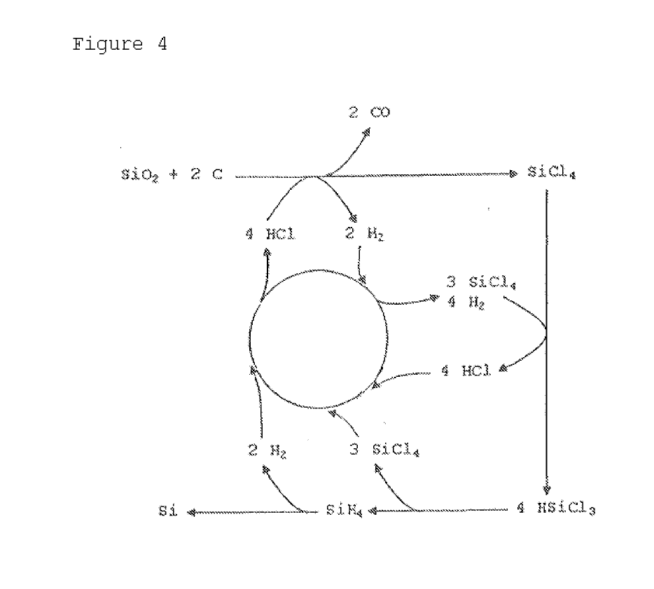

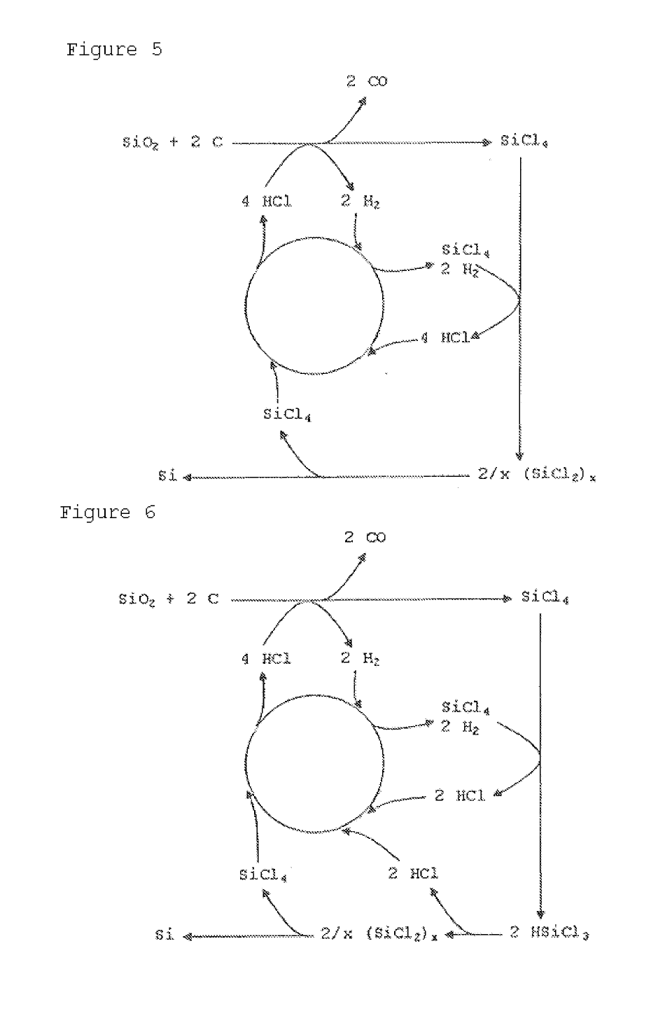

### WORKING EXAMPLE

### 1. Carbochlorination

4 g of finely divided quartz are mixed with 4 g of activated carbon powder, 2 g of wheat flour and a little water, converted to a paste and granulated (grain diameter approx. 1-3 mm). The material is thoroughly dried (80° C.), introduced into a quartz glass tube of diameter 2.5 cm between quartz wool plugs, and calcined thoroughly at up to 1050° C. (tube furnace). About 20 ml/s of HCl gas are passed through this bed at 1050° C. over a period of 1.5 h. The vapors formed are condensed in a cold trap at −50° C. After thawing, about 1.2 g=38% of theory (theoretical yield based on HCl) of SiCl₄ are isolated as a colorless liquid and characterized by ²⁹Si NMR spectroscopy.

### 2. Plasma Reaction for Production of Chlorinated Polysilanes

A mixture of 300 sccm of H₂ and 600 sccm of SiCl₄ (1:2) is introduced into a quartz glass reactor, while keeping the process pressure constant within the range of 1.5-1.6 hPa. The gas mixture is then converted to the plasma state by means of a high-frequency discharge, with precipitation of the chlorinated polysilane formed onto the cooled (20° C.) quartz glass walls of the reactor. The power introduced is 400 W. After 4 hours, the orange-yellow product is removed from the reactor by dissolution in a little SiCl₄. After removal of the SiCl₄ under reduced pressure, 187.7 g of chlorinated polysilane remain in the form of an orange-yellow viscous material.

The mean molar mass is determined by cryoscopy and is about 1400 g/mol, which, for the chlorinated polysilane (SiCl₂)ₙ or SiₙCl₂ₙ₊₂, corresponds to a mean chain length of about n=14 for (SiCl₂)ₙ or about n=13 for SiₙCl₂ₙ₊₂.

The ratio of Si to Cl in the product mixture, after digestion, is determined by chloride titration according to MOHR to be Si:Cl=1:1.8 (corresponding to the empirical (analytical) formula SiCl_{1.8}).

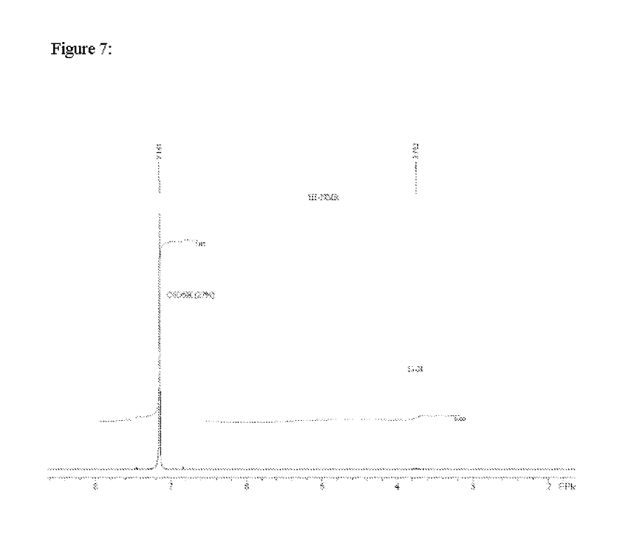

The hydrogen content is well below 1% by mass (0.0008%) (also below 1 atom %), as can be inferred from the ¹H NMR spectrum shown in FIG. 7. For this purpose, the integrals for the solvent at δ=7.15 ppm and for the product at δ=3.75 ppm are compared.

The content of the C₆D₆ solvent here is approx. 27% by mass, and the degree of deuteration thereof is 99%.

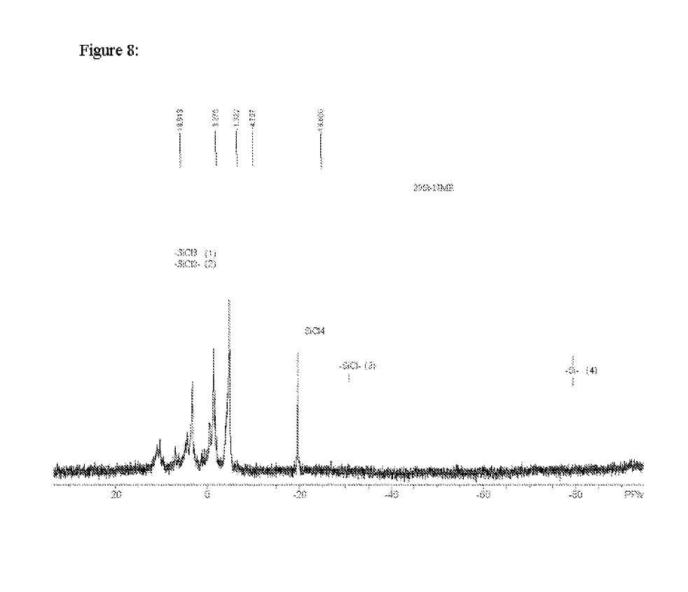

Typical ²⁹Si NMR shifts at approx. 10.9 ppm, 3.3 ppm, −1.3 ppm and −4.8 ppm are evident from the spectrum shown in FIG. 8. In the case of (1) and (2), these signals occur within the shift range typical of signals for SiCl₃ end groups (primary silicon atoms), and (2) is within a shift range typical of signals for SiCl₂ groups (secondary silicon atoms), as occur, for example, as intermediate members in the region of linear chains.

The low content of short-chain branched compounds, for example decachloroisotetrasilane (inter alia δ=−32 ppm), dodecachloroneopentasilane (inter alia δ=−80 ppm) (in the case of (3), these signals are within the shift range typical of signals for Si—Cl groups (tertiary silicon atoms), and (4) is within a shift range typical of signals for silicon groups with exclusively silicon substituents (quaternary silicon atoms)), is clear on the basis of the spectrum which follows. Integration of the ²⁹Si NMR spectra shows that the content of silicon atoms which form the branching sites mentioned (Si—Cl groups (tertiary silicon atoms) and silicon groups with exclusively silicon substituents (quaternary silicon atoms)) in the short-chain component, based on the overall product mixture, is 0.3% by mass, and is thus smaller than 1% by mass.

Low molecular weight cyclosilanes were undetectable in the mixtures. These should give sharp signals at δ=5.8 ppm (Si₄Cl₃), δ=−1.7 ppm (Si₅Cl₁₀), δ=−2.5 ppm (Si₆Cl₁₂) in the ²⁹Si NMR spectra, but these cannot be identified reliably in the spectrum, since the spectrum has a multitude of signals within this range.

The peak at approx. −20 ppm originates from the SiCl₄ solvent.

### 3. Decomposition of the Halogenated Polysilane to Si

The oily viscous product is heated in a tube furnace to 800° C. under reduced pressure. This forms a gray-black residue (2.2 g), which was confirmed as crystalline Si by X-ray powder diffractometry.

### 4. Conversion of the SiCl₄ Formed During the Process to the Halogenated Monosilane HSiCl₃ and Si

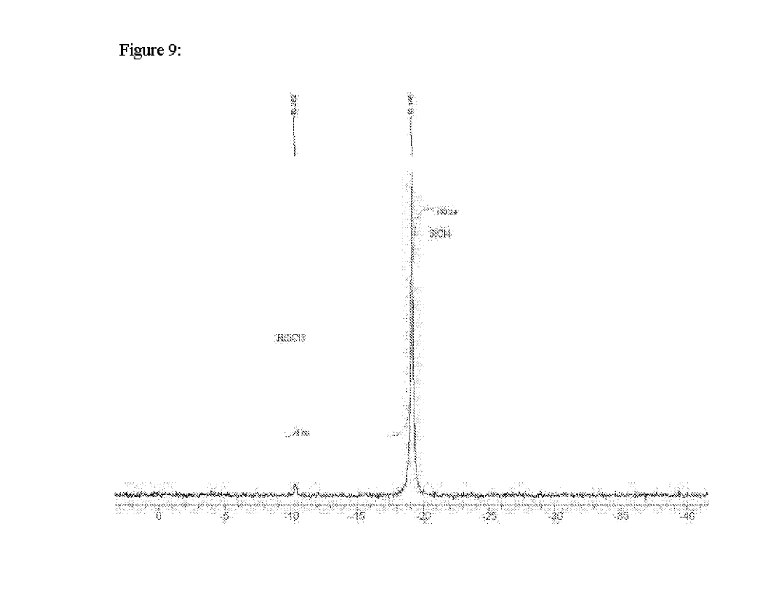

0.5 g of Si (grain diameter 0.2-0.4 mm) is layered onto a quartz boat (bed of length approx. 4 cm) and dried under argon in a quartz tube of diameter 2.5 cm. 20 l/h of hydrogen saturated with SiCl₄ vapor at 0° C. are passed over this bed for 16 min, while the bed is heated to a bright yellow glow by introduction of microwave power (300 W; 2.54 GHz). After the experiment has ended, the bed is weighed, and an increase in mass of 37 mg (5.5%) is observed through deposition of Si. The vapors are condensed in a cold trap at −50° C., and a colorless liquid is isolated, which is characterized by ²⁹Si NMR spectroscopy (see FIG. 9). It is found here that approx. 3% of the SiCl₄ is converted to HSiCl₃ during the reaction.

1. A method for preparing high-purity silicon, comprising:
preparing SiCl₄ by carbochlorination from SiO₂-containing starting materials; and
obtaining the high-purity silicon from the SiCl₄, with no supply of elemental silicon.

2. The method according to claim 1, wherein by-products obtained in the method are recycled into the method and reused therein.

3. The method according to claim 1 or 2, wherein HCl obtained in the method is used for carbochlorination.

4. The method according to claim 1, wherein the high-purity silicon is prepared by hydrogenating the SiCl₄ obtained to give chlorinated monosilanes (HₙSiCl₄₋ₙ (n=1-3)) and decomposition of these monosilanes.

5. The method according to claim 4, wherein the HCl obtained by decomposition of the chlorinated monosilanes is used for carbochlorination.

6. The method according to claim 4 or 5, wherein hydrogen obtained during the carbochlorination reaction or the decomposition of the chlorinated monosilanes is used for hydrogenation of the SiCl₄ to give the chlorinated monosilanes.

7. The method according to claim 4, wherein SiCl₄ which forms as a by-product during the decomposition of chlorinated monosilanes (HₙSiCl₄₋ₙ (n=1-3)) to give high-purity silicon is used for preparation of chlorinated monosilanes (HₙSiCl₄₋ₙ (n=1-3)) by reaction with hydrogen.

8. The method according to claim 1, wherein the SiCl₄ obtained is hydrogenated to chlorinated monosilanes (HₙSiCl₄₋ₙ (n=1-3)), the chlorinated monosilanes are converted by dismutation to SiH₄ and SiCl₄, and the SiH₄ obtained is decomposed to high-purity elemental silicon and H₂.

9. The method according to claim 8, wherein hydrogen which is obtained during the carbochlorination reaction is used together with further hydrogen from the decomposition of SiH₄ to give high-purity elemental Si for hydrogenation of SiCl₄ to give chlorinated monosilanes with elimination of HCl.

10. The method according to claim 8 or 9, wherein the SiCl₄ which forms in the dismutation reaction of chlorinated monosilanes is used to obtain chlorinated monosilanes by reaction with hydrogen.

11. The method according to claim 1, wherein the SiCl₄ obtained is used in a plasma-chemical process to obtain chlorinated polysilanes with elimination of HCl, and in that high-purity silicon is prepared by pyrolysis of the chlorinated polysilane.

12. The method according to claim 11, wherein the HCl obtained is used for carbochlorination.

13. The method according to claim 11 or 12, wherein the hydrogen obtained during the carbochlorination reaction is used in the plasma-chemical method.

14. The method according to claim 11, wherein SiCl₄ obtained during the pyrolysis of the chlorinated polysilane is recycled into the plasma-chemical process step.

15. The method according to claim 1, wherein the SiCl₄ obtained is hydrogenated to chlorinated monosilanes (HₙSiCl₄₋ₙ (n=1-3)), the chlorinated monosilanes obtained are used to produce chlorinated polysilanes in a plasma-chemical process with elimination of HCl, and high-purity silicon is prepared by pyrolysis from the chlorinated polysilanes.

16. The method according to claim 15, wherein the hydrogen obtained during the carbochlorination reaction is used for hydrogenation of the SiCl₄ with elimination of HCl.

17. The method according to claim 15 or 16, wherein SiCl₄ obtained during the pyrolysis of chlorinated polysilanes to elemental Si is used to obtain chlorinated monosilanes by reaction with hydrogen.

18. The method according to claim 11, wherein HCl and/or H₂ and/or chlorinated monosilane released during the pyrolysis of chlorinated polysilane is recycled into the method for preparing chlorinated polysilane.

19. The method according to claim 11, wherein chlorinated polysilane is obtained in a plasma-chemical process with elimination of HCl using mixtures of SiCl₄ and chlorinated monosilanes (HₙSiCl₄₋ₙ (n=1-3)).

20. The method according to claim 3, wherein CO obtained during the production of SiCl₄ by carbochlorination of SiO₂ with HCl is converted by carbon oxide conversion with water vapor to CO₂ and hydrogen.

21. The method according to claim 20, wherein hydrogen obtained by carbon oxide conversion is used to compensate for losses of H₂ during the performance of the method.
